(19) United States
(12) Patent Application Publication
(10) Pub. No.: US 2013/0198279 A1
(43) Pub. Date: Aug. 1, 2013

(54) Targeted Delivery of Content

(71) Applicants: Kai Liu, San Diego, CA (US); John D. Smith, Fallbrook, CA (US); Norifumi Takaya, San Diego, CA (US); David Tao, San Diego, CA (US)

(72) Inventors: Kai Liu, San Diego, CA (US); John D. Smith, Fallbrook, CA (US); Norifumi Takaya, San Diego, CA (US); David Tao, San Diego, CA (US)

(21) Appl. No.: 13/364,700

(22) Filed: Feb. 2, 2012

Related U.S. Application Data
(63) Continuation of application No. 13/362,964, filed on Jan. 31, 2012.

(51) Int. Cl. G06F 15/16

(52) U.S. Cl. 709/204

(57) ABSTRACT

A targeted delivery of content and related metadata is made to users of various types of electronic devices that are adapted to render or play the content. Images of each user are captured at various times while various items of the content are being played. According to one embodiment the images are processed via one or more facial recognition algorithms so that the identity of each of the users, including their names, is determined. This data is stored in a central server thereby establishing a database of profiles of these users. The profiles are comprised of tracking information of content played by each of the users on a per-content basis. The central server either uses this tracking information directly or transmits it to another server or another business entity, such as for example another content provider, for use by the other business entity.

### CROSS REFERENCE TO RELATED APPLICATIONS

This application is a continuation of, and claims the benefit of priority from U.S. application Ser. No. 13/362,964, entitled “Targeted Delivery of Content,” filed on Jan. 31, 2012, which such application is incorporated herein by reference in its entirety.

### 1. FIELD OF INVENTION

Embodiments of the present invention generally relate to data processing, and more particularly, but not exclusively, to a method and system for generating and presenting content (including commercial programs), or information related to the content, that is targeted to specific users.

### 2. BACKGROUND

Traditional content delivery methods involve the broadcasting of advertising along with other programming material to multiple users of televisions or radios in the same geographic area. For example, this content may be broadcast through a television or radio station in a content stream.

In order to reach users of a television or radio who have a certain demographic characteristic, such as for example users of a certain age range and/or sex, content providers, including advertisers, may be forced to broadcast their content at certain time slots on one or more channels that targeted users are likely to be receiving based upon demographic research. Advertisers usually have been forced to purchase time slots for both television and radio advertising in delivering their message. This is an indirect approach to reaching a target audience with built in inefficiencies and redundancies.

Television and radio traditionally are one-way mediums that permit distribution to a large geographic area. That is, all users within the geographic area receive the same programming and advertisements which are the same regardless of the identity of the actual user.

### SUMMARY OF CERTAIN EMBODIMENTS

Broadly speaking, certain embodiments of the invention relate to a targeted delivery of content and related metadata to users of various types of electronic devices that are configured to render or play the content. Each of these devices has a camera for capturing images of each user at various times while various items of content are being played. According to one embodiment, the images are processed via one or more facial recognition algorithms so that the identity of the users, including their names, is determined. This data is stored in a central server thereby establishing a database of profiles of these users. The profiles are comprised of tracking information of content played by each of the users on a per-content basis. The central server either can use this tracking information directly for the targeted delivery of content/metadata, or it can transmit it to another server or another business entity, such as for example another content provider, for use by the other business entity.

According to another embodiment, tracking information of content played by a first user on a per-content basis on a first device is received from the first device. At least a portion of the tracking information is generated by processing a plurality of images of the first user to determine his/her identity by performing facial recognition using at least one facial recognition algorithm by at least one processor. The plurality of images is generated by a camera in communication with the first device while the first user was playing the content on the first device. The tracking information, which is indexed to the identity of the first user, is stored. A first query comprised of the identity of the first user is transmitted to a social network server that is associated with a social network service. In response to the first query an identity of a plurality of other users who are members of the social network service and who are associated with the first user is received from the social network server. An identity of at least a portion of the content that was played by the first user on the first device is transmitted to the plurality of other users. This is transmitted automatically and in response to the receiving of the identity of the plurality of other users.

In one aspect, the identity of the at least the portion of the content comprises titles of the at least the portion of the content. Designations by the first user of the titles which correspond to content that is preferred by the first user are transmitted to the plurality of the other users.

In another aspect, the tracking information further comprises a number of times the content was played by the first user on the per-content basis, and the at least the portion of the content comprises the content that was played a predetermined number of times by the first user.

In another aspect, the content comprises a plurality of commercial advertising programs.

In another aspect, the plurality of other users are associated with the first user by being within three degrees of separation from the first user, or alternatively within one degree of separation from the first user. Alternatively still, the plurality of other users is associated with the first user by a designation on the social network service as a friend of the first user.

In another aspect, the transmitting to the plurality of other users further comprises transmitting social network information to the social network server for posting on a plurality of web pages of the social network service that are associated with the plurality of other users. The social network information includes the identity of the at least the portion of the content that was played by the first user on the first device.

In another aspect, the tracking information that is indexed to the identity of the first user is transmitted to a content provider server that is associated with a content provider.

In another aspect, selected content is transmitted from the content provider server to the plurality of other users. The selected content is content determined by the content provider server to be linked to the plurality of other users.

In another aspect, the identity of the plurality of other users is transmitted to the content provider server.

In an alternative embodiment, a database of a plurality of profiles of a plurality of users is established in a computer environment. The plurality of profiles is comprised of tracking information of content played by each of the plurality of users on a per-content basis on a plurality of devices. The tracking information is automatically generated by processing a plurality of images of each of the plurality of users to determine an identity of each of the plurality of users by performing facial recognition using at least one facial recognition algorithm by at least one processor. The plurality of images is generated by a plurality of cameras in communication with the plurality of devices while the plurality of users were playing the content on the plurality of devices.

A first query comprised of the identity of a first user who is one of the plurality of users is transmitted to a social network server that is associated with a social network service. In response to the first query a plurality of content recommendations of a portion of the plurality of users who are members of the social network service and are associated with the first user is received from the social network server. The plurality of content recommendations of the portion of the plurality of users is transmitted to the first user.

In one aspect, an identity of each of the portion of the plurality of users is received from the social network server in response to the first query. The transmitting of the plurality of content recommendations to the first user further includes transmitting to the first user the identity of each of the portion of the plurality of users.

In another aspect, the plurality of content recommendations includes titles of content that is preferred by the portion of the plurality of users.

In another aspect, the tracking information further comprises a number of times each item of the content was played by each of the plurality of users on the per-content basis. The content that is preferred by the portion of the plurality of users comprises the content that was played a predetermined number of times by the portion of the plurality of users.

In another aspect, the content played by each of the plurality of users on the per-content basis on the plurality of devices comprises a plurality of commercial advertising programs.

In another aspect, the plurality of other users are associated with the first user by being within three degrees of separation from the first user, or alternatively within one degree of separation from the first user. Alternatively still, the plurality of other users are associated with the first user by a designation on the social network service as a friend of the first user.

In another aspect, the transmitting to the first user includes transmitting social network information to the social network server for posting on a web page of the social network service that is associated with the first user. The social network information includes the plurality of content recommendations of the portion of the plurality of users.

In another aspect, the tracking information indexed to the identity of the portion of the plurality of users is automatically transmitted to a content provider server that is associated with a content provider.

In another aspect, the plurality of content recommendations of the portion of the plurality of users is transmitted to the content provider server.

In another aspect, selected content is transmitted by the content provider server to the portion of the plurality of users. The selected content is content determined by the content provider server to be linked to the tracking information.

In an alternative embodiment, tracking information of content played by a first user on a per-content basis on a first device is received from the first device. At least a portion of the tracking information is generated by processing a plurality of images of the first user to determine an identity of the first user by performing facial recognition using at least one facial recognition algorithm by at least one processor. The plurality of images is generated by a camera in communication with the first device while the first user was playing the content on the first device.

The tracking information indexed to the identity of the first user is stored in a central server. A first query comprised of the identity of the first user is transmitted to a social network server that is associated with a social network service. In response to the first query a plurality of content recommendations of a plurality of other users who are members of the social network service and are associated with the first user by the social network service is received from the social network server. The plurality of content recommendations of the plurality of other users is storied in the central server. A subsequent image of the first user is received from a second device. The subsequent image was generated by a camera in communication with the second device while the first user was using the second device. The subsequent image of the first user is processed to automatically determine the identity of the first user by performing facial recognition. The processing occurs while the first user is using the second device. The plurality of content recommendations of the plurality of other users is transmitted from the central server to the second device. This transmitting of the plurality of the content recommendations occurs automatically and after the processing of the subsequent image of the first user.

In one aspect, in response to the first query an identity of each of the plurality of the other users is received from the social network server.

In another aspect, the first device is a TV, and the second device is a smart phone or a tablet computer.

In another aspect, the content comprises a plurality of commercial advertising programs.

In another aspect, the plurality of other users are associated with the first user by being within three degrees of separation from the first user, or alternatively within one degree of separation from the first user. Alternatively still, the plurality of other users are associated with the first user by a designation on the social network service as a friend of the first user.

In another aspect, social network information is transmitted to the social network server for posting on a plurality of web pages of the social network service that are associated with the plurality of the other users. The social network information includes an identity of at least a portion of the content that was played by the first user on the first device.

In another embodiment, a plurality of images of a plurality of users of a plurality of devices is received. Each of the plurality of images was generated by a camera in communication with a corresponding one of the plurality of devices while a corresponding one of the plurality of users was using the corresponding one of the plurality of devices. Each of the plurality of images is processed to determine an identity of each of the plurality of users by performing facial recognition using at least one facial recognition algorithm by at least one processor. The identity of each of the plurality of users is associated with content being played by each such user at the time that the image of each such user was being generated.

A subsequent image of a combination of the plurality of users is received. The subsequent image was generated by one of the plurality of cameras in communication with the corresponding one of the plurality of devices while the plurality of users were disposed adjacent to one another and adjacent to the corresponding one of the plurality of devices. The subsequent image is processed to automatically determine the identities of each of the plurality of users. Relationship information is displayed on the corresponding one of the plurality of devices after the processing of the subsequent image. The relationship information corresponds to information derived from the associating of the identity of each of the plurality of users with content being played by each such user at the time that the corresponding image of each such user was being generated.

In one aspect, the identity of each of the plurality of the users includes the name of each of the plurality of users. The displaying of the relationship information includes displaying an identity of one or more common items of content, each of which was played by at least two of the plurality of users at the time that the corresponding image of each such user was being generated. The displaying of the relationship information further includes displaying the name of each of the at least two of the plurality of users.

In another aspect, each of the one or more common items of content is a commercial advertisement program.

In another aspect, each of the plurality of devices comprises a TV with the camera embedded within the TV. The TV is configured to transmit the plurality of images to a destination on a network.

In another aspect, the processing of each of the plurality of images further comprises identifying an expression of a sentiment of each of the plurality of users. The relationship information further includes the sentiment of each of the plurality of users.

In another aspect, the processing of each of the plurality of images further comprises determining whether a face or a pair of eyes of each of the plurality of users is directed toward a display of the corresponding one of the plurality of devices.

In another aspect, the information derived from the associating of the identity of each of the plurality of users with content being played by each such user at the time that the corresponding image of each such user was being generated is transmitted to a content provider server that is associated with a content provider. The transmitting to the content provider server of this information occurs prior to the displaying of the relationship information which is provided by the content provider server.

In another embodiment, a device comprises a memory and a processor coupled to the memory. The processor is operable to perform the steps of any of the above-described embodiments.

In yet another embodiment, a non-transitory, computer-readable storage medium is provided. The storage medium contains instructions that, when executed by a processor, cause the processor to perform the steps of any of the above-described embodiments.

There are additional aspects to the present inventions. It should therefore be understood that the preceding is merely a brief summary of some embodiments and aspects of the present inventions. Additional embodiments and aspects are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of certain embodiments, taken in conjunction with the accompanying drawings of which:

FIG. 1 is a simplified block diagram of an operating environment in which an embodiment of the invention may be used;

FIG. 2 is a simplified block diagram of the television of FIG. 1;

FIG. 3 is a simplified process flow diagram of a method for targeted content or metadata delivery according to one embodiment of the invention;

FIG. 4 is a simplified process flow diagram of a method for targeted content or metadata delivery using a social network service according to one embodiment of the invention; and

FIG. 5 is a simplified process flow diagram of another method for targeted content or metadata delivery using a social network service according to another embodiment of the invention.

### DETAILED DESCRIPTION

The following description is of the best mode presently contemplated for carrying out the invention. Reference will be made in detail to embodiments of the present invention, examples of which are illustrated in the accompanying drawings, wherein like reference numerals refer to like elements throughout. It is understood that other embodiments may be used and structural and operational changes may be made without departing from the scope of the present invention.

Embodiments of the invention relate to systems and methods for a targeted delivery of content and related metadata to users of various types of electronic devices that are adapted to render or play the content. The content can be audio content, video content or both. Each of these devices has a camera for capturing images of each user at various times while various items of content are being played. According to one embodiment the images are processed either locally on the devices or remotely on other devices so that the identity of each of the users, including their names, is determined via one or more facial recognition algorithms. This data is stored in a central server thereby establishing a database of profiles of these users. The profiles are comprised of tracking information of content played by each of the users on a per-content basis. The central server either can use this tracking information directly for targeted delivery or can transmit it to another business entity, such as for example another content provider, for use by this other business entity.

By using this tracking information and gathering and incorporating other information (such as for example the content favorites of each user, any relationships among the users as determined by social network services, by facial recognition of group photos or images, or by other means), the targeted delivery of content can be enhanced. In some embodiments the tracking information is enhanced by determining, via the facial recognition algorithms, the identity of a sentiment of each user, such as for example smiling, laughing, crying or frowning, while he/she is playing the content. Additionally facial recognition algorithms can be used to determine whether a user's eyes or face is directed toward the display of the device, thus providing an indication of whether or not the user likely is paying attention to the content. The identification of such sentiments and attentiveness, along with their association with the content being played, provides further information about the emotional or other reaction of each user to the content, including whether the user is even paying attention.

In some embodiments the targeted delivery can occur so that the content that a user is playing is modified by a content provider in real time based upon the stored profile data. Also, content that is a favorite of each user can be determined automatically by recording the identity of various items of content played by each user while capturing his/her image at many points of time. Favorite or preferred content can further be identified by other than automatic methods, such as for example receiving a user command or text entry or other manual designation or input. Preferences and other user patterns can be dynamically tracked as they change over time as a function of changing user interests and preferences. Moreover because the tracking information is being stored and maintained centrally, targeted content and metadata delivery to a user can occur at different points in time on two or more different types of devices. For example, tracking information of a user may be gathered while that user is watching a TV having a camera. At some later point in time this user may be playing content on his/her smart phone that also has a camera. When the identity of this user is recognized to be the person who actually is using the smart phone (via facial recognition using the camera of the smart phone), the centrally-maintained tracking information can be used for delivery of the targeted content or metadata to the smart phone in real time.

In some embodiments tracking information can be sent to and received from a social networking service in order to determine the identity of users who are related to one another, and in order to cause to be posted on the social network web pages of a first group of users, the identity of the content that is being played or used by one or more other users (along with their identity by name, such as for example “Sally Smith” or “John Jones”) having an association with the first group. The posting on these web pages can occur in real time as the content is being used or played, or it can occur at a later point in time.

In some embodiments tracking information that is gathered based upon images of individual users can be used in group settings. For example when two or more users are located together and are playing content in front of a single device, such as a television (TV), a group image or photo is captured by a camera in communication with the TV. Through facial recognition techniques the identity of each user in the group is determined, and the previously-stored profile of each person is retrieved and compared with that of the others in the group image. Common user characteristics, preferences, favorites or other uses of content are identified, whereupon targeted content or metadata is transmitted to the TV in real time while the users are watching the TV. This targeted content or metadata can include a list of the names of the items of content that are preferred by two or more of the users in the group, along with the identity by name of those users. The targeted content can also include commercial advertisement programs that have been identified as likely to be preferred or enjoyed by two or more of the users in the group based upon common characteristics or preferences of these users. Moreover the content that is being played by the group can be tracked and retained so that the viewing habits, sentiments and preferences of the group as a whole can be used for follow-up targeted delivery of content/metadata.

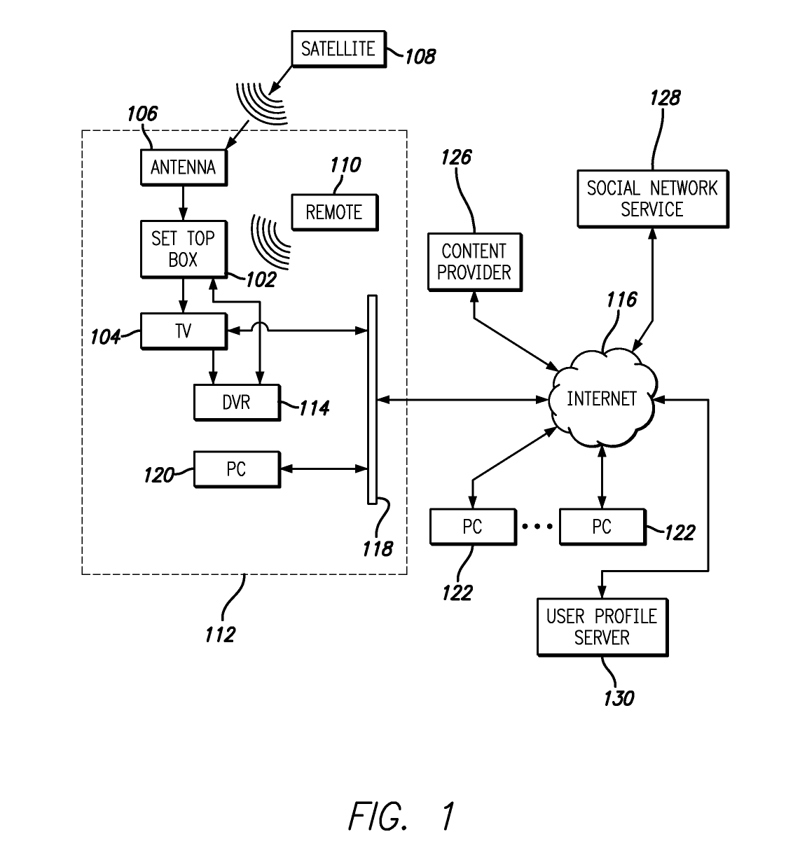

FIG. 1 is a simplified block diagram of an exemplary operating environment in which embodiments of the invention may be implemented. Content providers such as, for example, video, audio, data providers, and TV service providers, deliver to users programming and/or data which often is provided to a receiving device such as, for example, a set top box 102, that is in communication with a TV 104, or other device having a display screen and configured to receive and display the programming.

The set top box 102 in turn is in communication with a satellite antenna 106 configured to receive a signal from a communications satellite 108. In alternative embodiments the set top box 102 communicates with other data or programming sources such as, for example, an Ethernet portal, a telephone company network, a cable head-end, a terrestrial antenna, etc., that provide the programming or data. The set top box 102 processes and communicates the selected programming to the TV 104 and/or to one or more other TVs, presentation devices or storage devices.

While the illustrated embodiment shows a set top box 102, alternative embodiments include any suitable converter device or electronic equipment that is operable to receive programming and programming-related data or metadata. Examples of such alternative devices include a TV recording device, TV tuner, TV converter, receiver, satellite receiver, cable set-top box, cable receiver, media player, and/or TV receiving device. In some embodiments, a remote controller 110 is operable to control the TV 104 and other user devices.

While the illustrated embodiment shows the TV 104, alternative embodiments include other devices for the presentation of content or data such as, for example, a digital video recorder (DVR), a game system, a personal computer, a “smart” phone, a tablet computer, a sound system receiver, a compact disk (CD) device, etc. Certain of these devices have one or more speakers, a display, or other output components to present video or audio content to a user.

In some embodiments, a plurality of TVs or related devices for the presentation of content/data are disposed in or near a user's premises 112 and are in direct or indirect communication with the set top box 102. Further, the set top box 102 and the TV 104 may be integrated into a single device having the above-described functionality of the set top box 102 and the TV 104, in addition to having other functionality. In addition to program content, Electronic Programming Guide (“EPG”) data or similar such data is provided from a programming data source to the user's premises 112 via the Internet 116.

The receiver satellite antenna 106 is disposed at or near the user's premises 112 which can include, for example, a residence, a business, or any other location operable to receive satellite signals. The received satellite signal is communicated to the set top box 102 which amplifies and converts the received signal into a signal suitable for communication to the TV 104 or another user device such as, for example, a DVR 114.

In alternative embodiments rather than the DVR 114 (or in addition to the DVR 114), other devices may be used that are operable to receive a signal from the set top box 102, another endpoint device, or from other devices external to the premises 112. Additional examples of such devices include a compact disk (CD) recorder, a digital video disc (DVD) recorder, other optical media recorders, a personal video recorder (PVR), game devices, magnetic tape recorders, RF transceivers, and personal computers (PCs).

The remote controller 110 serves as one type of interface between a user and the set top box 102. The remote controller 110 communicates with the set top box 102 using a wireless medium, such as infrared (IR), RF, Bluetooth, etc. (In alternative embodiments the remote controller 110 communicates directly and wirelessly with the TV 104 and the DVR 114, as well as with the set top box 102.) In addition to the DVR 114 which is in communication with the set top box 102, other devices (not shown) may also be in communication with the set top box 102 such as, for example, pointing devices, game device controllers, keyboards, etc.

In alternative embodiments, the set top box 102 may receive content, video streams and data from sources other than the antenna 106 such as, for example, from locally broadcast RF signals, from the Internet 116 (via live streaming or otherwise) by using a local network 118 or from other communication systems.

The user's premises 112 includes other devices that are in communication with the Internet 116. They include the local network 118 to which a local PC 120 and the TV 104 are communicatively coupled. In alternative embodiments other devices such as, for example, data storage devices, the set top box 102, game systems, sound system receivers, Internet connection devices, digital subscriber loop (DSL) devices, wireless LAN, WiFi, Worldwide Interoperability for Microwave Access (WiMax), etc., are communicatively coupled with the local network 118 so that all such devices may communicate with one another and with the Internet 116. Additionally a plurality of remote PCs 122 that are disposed away from the premises 112 communicate with the local PC 120 and the TV 104 via the Internet 116 and the local network 118. Thus, the local network 118 allows these interconnected devices, and the set top box 102, to communicate with each other.

A content provider 126 comprises one or more servers that provide program content, such as video or audio content, to end users, or in some embodiments to a program distributor. Content providers can include special content providers that broadcast premium based programming or pay-per-view programming, TV stations that send audio/visual programming, or radio stations that broadcast audio programming. In some embodiments program content, or programs, is sent to the program distributor from the content providers via the Internet 116, although alternative embodiments include other communication media such as, for example, satellite systems, digital subscriber line (“DSL”) systems, radio frequency (“RF”) systems, telephony systems, cable systems, fiber optic systems, microwave systems, asynchronous transfer mode (“ATM”) systems, internets, intranets and frame relay systems. Moreover content and data can be communicated by combinations of the foregoing communications media. In addition to program content, Electronic Programming Guide (“EPG”) data or similar such data is provided from the content provider 126 or from another programming data source to the user's premises 112 via the Internet 116 or other signal transmission channels. As used herein, content provider refers to and includes one or more providers of news, informational, advertising and entertainment content (audio, visual or both), EPG data or other types of programming information, as well as providers of data and metadata related to entertainment, news, informational and/or advertising content.

In some embodiments the program content is converted by one or more devices at the program distributor into a suitable signal that is communicated or “uplinked” by an antenna to the satellite 108. The uplinked signal is received by the satellite 108 and then communicated or “downlinked” from the satellite 108 onto a geographical region. The receiver antenna 106 receives the downlink satellite signal. In alternative embodiments the receiver antenna 106 is operable to receive signals from a plurality of satellites or from terrestrial transmitters.

A user profile server 130 is comprised of one or more servers that obtain user information via the Internet 116 from the TV 104, the local PC 120, the plurality of remote PCs 122, and in some embodiments from a social network service 128. The user profile server 130 compiles the user information (including in some embodiments information obtained by facial recognition algorithms) and transmits it to the TV 104, the local PC 120, the plurality of remote PCs 122, the social network service 128, and in some embodiments to the content provider 126, which in turn transmits the user information to certain content users, or which uses the information for directing certain content to targeted users.

The social network service 128 also is connected to the Internet 116 and can communicate with the user profile server 130, the content provider 126, as well as the TV 106, the local PC 120, and the remote PCs 122 via the Internet 116. Some social network services permit a user to obtain information by interacting with one or more other users or members of these services. Using some social network services, a user may create a profile and establish links to other users who also maintain profiles on the service. Known examples of such services include Facebook, Inc. of Palo Alto, Calif., MySpace™ of Beverly Hills, Calif., and LinkedIn™ of Mountain View, Calif., etc. Another known type of social network service is Twitter™ of San Francisco, Calif. With this type of service a user can send short messages (sometimes called “tweets”) to recipients (sometimes called “followers”) who wish to receive these messages. Although FIG. 1 depicts the social network service 128 as one drawing element, in many embodiments the social network service is comprised of a plurality of servers that are in direct or indirect communication with the Internet 116. In some embodiments these social network servers include an application server and a plurality of graph servers that are interconnected by a network or the Internet 116. The application server manages one or more databases for retaining member information, relationship information, and search information.

According to one embodiment the social network member information contained in the databases can include profile information for each member of the social network service 128. This profile information can include, for example, a member name, age, gender, religion, location, member attributes, hometown, references to image files, listing of interests, schools attended, past and present occupations, past and present employers, favorite or preferred movies, books, persons and other preferred things, etc. The relationship information contained in the databases defines one or more relationships between members, such as for example, a degree of relationship between members, a degree of relationship status or designation (such as for example the designation “friend”), a familial relationship, and other types of interdependency, such as for example, friendship, common interest, financial exchange, occupation, employer, job description, dislike, sexual relationships, or relationships of beliefs, knowledge or prestige, etc. In addition, the information stored in the databases of the social network service 128 are indexed so that the information can be optimized for search, and stored in one or more databases as the search information. These social network service 128 databases are updated to reflect changes to existing member information as well as new member information that are provided through the remote PCs 122, the TV 104, the local PC 120 as well as other devices via the Internet 116.

The application server portion of the social network service 128 of this embodiment also manages queries or other types of information requests that it receives from the local PC 120, the TV 104, the remote PCs 122, the user profile server 130 and other devices via the Internet 116. The graph servers portion of the social network service 128 manage the representations of the social network for all the members. The graph servers also can receive queries, process them and return the query results to the system's application server.

The above description of the operating environment, including the user's premises 112 and the various devices disposed therein, is intended as a non-limiting overview of one of various embodiments of an operating environment in which embodiments of the invention may be implemented. The devices in the user's premises 112 and the internal and external communication systems, may contain other devices, systems and media not specifically described herein.

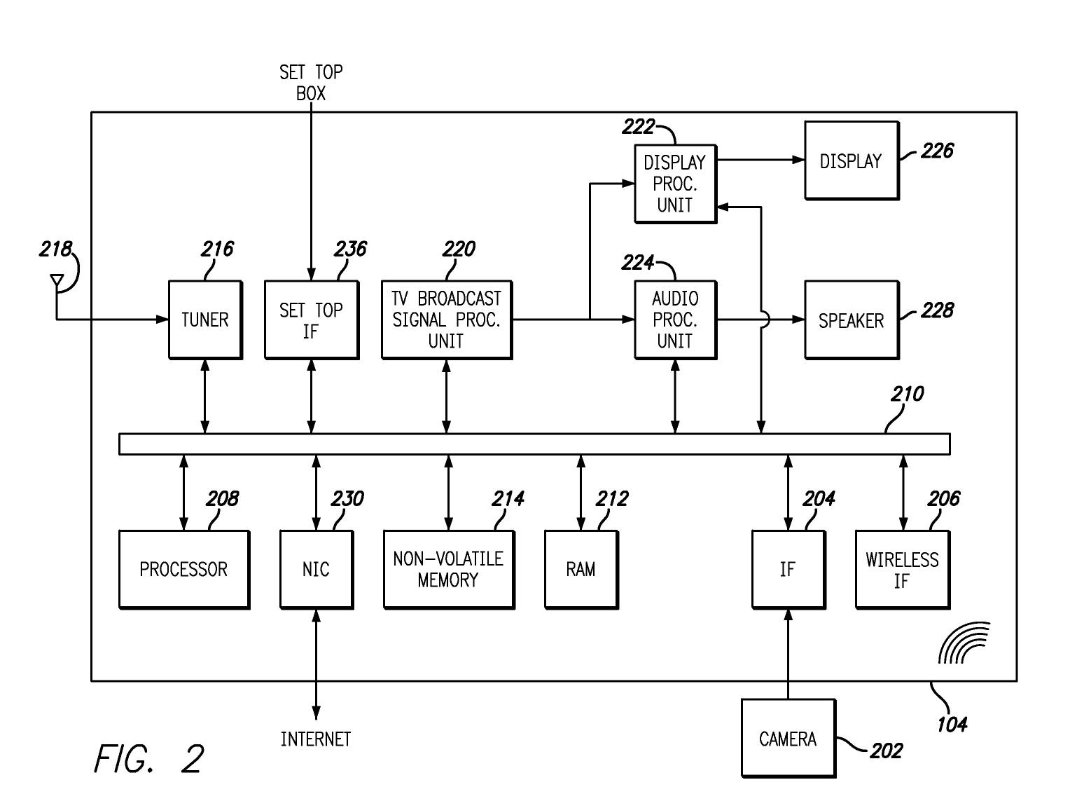

FIG. 2 is a simplified block diagram of the TV 104 of FIG. 1 in accordance with an embodiment of the invention. The TV 104 is cable connected to a camera 202 via an external interface 204. In alternative embodiments however the camera 202 is a component that is integral to or embedded in the TV 104. Moreover, the TV 104 is wirelessly connected to the remote controller 110 via a wireless interface 206.

A central processing unit (CPU) or processor 208 performs central control over various units and communicates with them via a system bus 210. The processor 208 executes one or more programs that are temporarily stored in a random access memory (RAM) 212. The programs are further stored in a nonvolatile memory 214 prior to their transfer to the RAM 212 for use. The non-volatile memory 214 (or storage unit) includes a non-transitory, computer-readable storage medium and is for storing relatively large quantities of data, applications, etc. The non-volatile memory 214 can be one or more hard disk drives, flash memory devices, optical drives, etc. The processor 208 reads the programs and performs various processing and controls various units in accordance with the programs.

As another user interface the processor 208 recognizes commands initiated by the user via the remote controller 110 (FIG. 1) in accordance with the commands sent from the remote controller 110 and performs processing in accordance with this operation.

Moreover, the TV 104 has a broadcast processing function. When the TV 104 is instructed by a user command to output a broadcast signal, the TV 104 inputs, to a tuner 216, a terrestrial broadcast signal received by an external antenna 218. The processor 208 causes the tuner 216 to obtain the broadcast signal of a selected channel through the operation performed by the user, and sends this signal to a broadcast signal processing unit 220.

The processor 208 causes the broadcast signal processing unit 220 to obtain video data and audio data of a program from this broadcast signal by performing processing on it. From among this data, video data is sent from the broadcast signal processing unit 220 to a display processing unit 222, and audio data is sent from the broadcast signal processing unit 220 to an audio processing unit 224. The processor 208 further causes the display processing unit 222 to obtain a video signal by performing display processing on the video data, and sends this video signal to a display 226. As a result, video of a program is displayed for the user. The processor 208 also causes the audio processing unit 224 to obtain an audio signal by performing audio processing on the audio data, and sends this audio signal to a speaker 228. As a result, audio of the program is output from the speaker 228.

In addition to receiving the terrestrial broadcast signal via the antenna 218, the TV 104 further receives signals from the satellite antenna 106 via the set top box 102. (FIG. 1) These signals are transmitted to a set top box interface 236 which in turn processes and transmits them to the bus 210 for further processing in a manner that is generally similar to that described above.

A network interface card (NIC) 230 is connected to the bus 210 and serves as an interface with the Internet 116 via the local network 118 so that the processor 208 may send and receive data to and from the Internet as well as other components in communication with the local network 118.

The camera 202 is connected to the TV 104 via the external interface 204 of the TV 104 so that the image data generated by the camera 202 can be sent to the processor 208. According to one embodiment the TV 104 recognizes one or more users who are in front of the TV 104 in accordance with the image data sent from the camera 202. Specifically, the processor 208 of the TV 104 performs facial detection and recognition processing on the image data generated by the camera 202. The processor 208 detects the face of one or more users by performing this detection processing. In alternative embodiments the image data is sent to another device which performs the facial detection and recognition processing on the image data.

There are various known algorithms for facial detection and facial recognition. For example according to one algorithm, an area of skin color and feature values (portions assumed to be the eye and mouth) within this area of skin color are extracted from a camera image, and it is determined whether the area of skin color is the face in accordance with a position relationship between these feature values. The processor 208 detects areas, each of which is determined to be the face, from a camera image by using such an algorithm, and obtains the coordinates of each of the detected face areas.

The remote PCs 122 (FIG. 1) are also each comprised of generally similar components, including cameras, that are arranged in a generally similar configuration as that of the TV 104 of FIG. 2. In some embodiments the connections between the local PC 120, the remote PCs 122 and the TV 104 can be wireless or via one or more cables or via any combination thereof. In the illustrated example, only a certain number of PC's, servers and one TV are shown, but those skilled in the art will appreciate that any number of devices and TVs may be connected to the local network 118, the Internet 116 or another type of network. The PCs 120, 122 provide functions for transferring electronic messages and other data from one device to another or to the TV 104, sometimes via other message servers or electronic devices.

In a manner similar to the TV 104, each of the remote PCs 122 includes a processor, a read-only memory (ROM), a RAM and a storage unit, all of which are coupled or interconnected via a bus. The processor is configured to execute a variety of processing operations as directed by programs and applications stored in the ROM or loaded from a storage unit into the RAM. The storage unit or non-volatile memory includes a non-transitory, computer-readable storage medium and is for storing relatively large quantities of data, applications, etc. The storage unit can be one or more hard disk drives, flash memory devices, optical drives, etc. The RAM also stores data and so on necessary for the processor to execute a variety of applications and processing operations as required. The ROM, the RAM and/or the storage unit stores operating software and applications that are used along with the processor to enable the operation of each of the remote PCs 122.

The remote PCs 122 each further includes at least one input device, such as for example, a keyboard and a mouse, a microphone for receiving voice or other sound input, a camera for receiving images, a pointing device, a touch screen display, or a remote-controlled wireless input unit, such as for example a television remote control-type unit. Alternative embodiments can include any combination of the foregoing types of input devices, as well as other input devices. Thus the remote PCs 122 each permits user input via a user action that includes clicking a mouse button when a cursor is positioned over a pre-defined area of an output device, such as for example a display unit based upon a LCD. (The output device can further include a speaker for providing voice prompts and spoken words, music and system tones.) Other user actions for input can include a generation by the user of a sound or a gesture, a selection using the television-type remote control unit, a depressing of a key on the keyboard, a movement of the pointing device or a touching on the touch screen display with the pointing device or with the user's finger, or a selection of a displayed indication.

The bus of each of the remote PCs 122 further couples or connects the input device, the output device, the storage unit, and a communication device. The communication device can be a modem, a network interface card (NIC), a wireless access card or adapter, or other terminal adapter, for example. The communication device executes communication processing via the network, sends data supplied from the processor, and outputs data received from the network to the processor, the RAM, and the storage unit. The communication device also communicates analog signals or digital signals with other electronic devices.

The bus of each of the remote PCs 122 is also connected or coupled to a drive as required on which a non-transitory, computer-readable storage medium, such as a magnetic disk, an optical disk, a magneto-optical disk, or a semiconductor memory for example, is loaded with computer applications containing instructions or with other data read from any of these storage media. These instructions and data, when executed by the processor, cause it to perform a plurality of methods or functions. The local PC 120, the servers of the social network service 128, the servers of the content provider 126 and the user profile server 130 are each comprised of generally similar components that operate in a generally similar manner as that of the remote PCs 122. Moreover the set top box 102 and the DVR 114 of FIG. 1 similarly are each comprised of some of the components as described above for the remote PCs 122 and the TV 104, which such components operate in a generally similar manner.

While FIGS. 1 and 2 show one configuration of the TV 104, the remote PCs 122, the local PC 120 and other devices, alternative embodiments include a cellular phone, a so-called “smart” phone, a portable digital assistant, a tablet computer, a laptop computer, a server and any other type of a computer or processor-driven device, all of which include a camera in communication with a processor. Moreover, alternative embodiments need not incorporate a TV, but rather may include a communication among the PCs directly with each other.

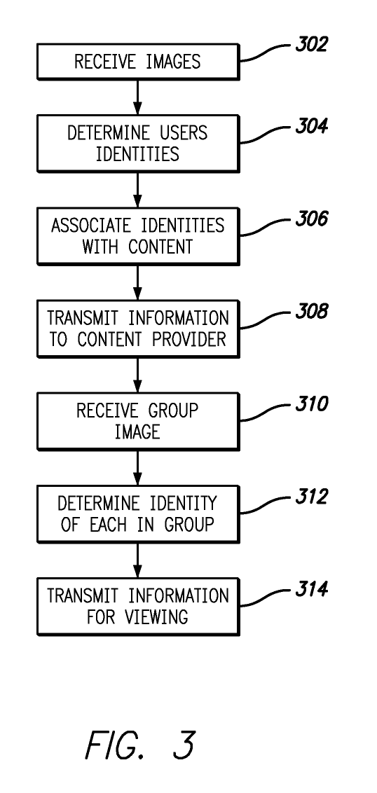

As previously mentioned, embodiments of the invention provide for a machine-implemented method for a targeted delivery of content or metadata over a network comprising a plurality of devices. The method is automatic and requires generally no human actions. FIG. 3 is a simplified process flow of one such embodiment. First, a plurality of images of a plurality of users is received by a plurality of devices. (Step 302) Each of the images is of an individual user and was automatically generated by a camera in communication with one of the plurality of devices while one of the users was using the device. Each of the images is automatically processed by one or more processors using one or more facial recognition algorithms to determine an identity of each of the users, including in some embodiments the actual name of each of the users, such as for example “Sally Smith” or “John Jones.” (Step 304) The identity of each user is automatically associated with content being played by him/her at the time that his/her image was generated. (Step 306) Information derived from this association is transmitted to a content provider server that is associated with a content provider. (Step 308)

Then at some later time a subsequent image of a combination or group of these users is received. (Step 310) The subsequent image was automatically generated by a camera in communication with a device having a processor (such as a TV, for example) while the users were disposed adjacent to one another and adjacent to the device. In other words a sort of group photo or image is received which includes the same users whose individual images had been previously received in Step 302. This subsequent image is processed by one or more processors using facial recognition algorithms to automatically determine the identities of each of the individual users who are presumed to be playing the content at that time, and this information also is transmitted to the content provider server. (Step 312) In response to the processing of the subsequent image, to the determining the identities of each of the plurality of users in the group image, and to the receipt of these identities by the content provider server, certain relationship information is automatically transmitted by the content provider server back to this device (e.g., the TV) which displays this relationship information for viewing by the group. (Step 314) The relationship information is based upon or corresponds to information derived from the associating of the identity of each of the users with content being played by each such user individually (such as in Step 306) at the time that the corresponding image of each such user was being generated.

In some embodiments the relationship information includes the identity of one or more common items of content (which could be a commercial advertisement program, for example), each of which was played by at least two of the users at the time that the individual image of each such user was being generated, and further includes the identity by name of those users. In other embodiments the relationship information further includes a sentiment of each of the users when he/she was playing an item of content. This sentiment information is obtained automatically as part of the facial image recognition processing which not only yields the users' identities, but also expressions of their sentiments as they are playing content, and/or whether their eyes or faces are directed toward the display of the device. Thus by determining an expression of smiling or laughing or paying attention, for example, information about each user's reaction to or interest in the content can be obtained automatically and compiled by one or more processors.

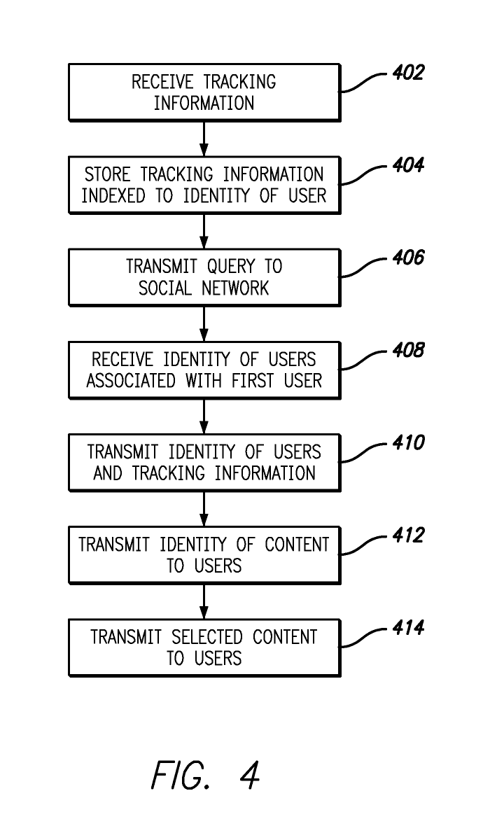

FIG. 4 is a simplified process flow of a machine-implemented method for a targeted delivery of content or metadata using a social network service according to an embodiment of the invention. The method is automatic and requires generally no human actions. First, tracking information of content played by a first user on a per-content basis on a first device is received. (Step 402) At least a portion of the tracking information is automatically generated by processing a plurality of images of the first user to determine his/her identity. This process is accomplished by one or more processors using one or more facial recognition algorithms. The images are automatically generated by a camera in communication with the first device and were taken at various points in time when the first user was playing the content (including playing various different items of content) on the device. Then the tracking information indexed to the identity of the first user (including in some embodiments the name of the first user) is stored. (Step 404)

A first query comprised of the identity of the first user is automatically transmitted to a social network server that is associated with a social network service. (Step 406) In response to the first query identities of a plurality of other users who are members of the social network service and who are associated with the first user are received from the social network server. (Step 408) The identities of these other users are then automatically transmitted to a content provider server associated with a content provider along with the tracking information indexed to the identity of the first user. (Step 410) The content provider server then transmits to the other users the identity of at least a portion of the content that was played by the first user on the first device. (Step 412) This content identity can include, for example, a list of content titles for content designated by the first user to be preferred by him/her, such as for example, a list of the first user's so-called favorites. The content identity information is included as part of the tracking information of the first user. Another example of this content identity could be a reference to content which was played a predetermined number of times by the first user, thus providing an automatic indication that he/she likely enjoyed or preferred the content. Yet another example could be that content which is associated with a user expression of smiling or laughing, or which is associated with likely attentiveness as measured by whether the user's face or eyes are directed toward a display while the content is playing.

Additionally, the content provider server further automatically transmits to the other users selected content which is content (including advertisements, for example) that is automatically determined by the content provider server to be linked to the other users. (Step 414) This linked content, for example, can be content that is targeted to users having a common preference, characteristic or background, such as for example users of a certain age group, a certain gender, occupation, income level, users who attended a certain college, etc. In some embodiments the other users are automatically associated with the first user by being within a certain number of degrees of separation from the first user as tracked by the social network service (such as for example three degrees or one degree) or being designated on the social network service as a “friend” of the first user. In an alternative embodiment, information is automatically transmitted to the social network server which results in the automatic posting of content identity on certain social network service web pages which are associated with the plurality of other users, wherein this content identity refers to the content that was played by the first user, along with his/her name.

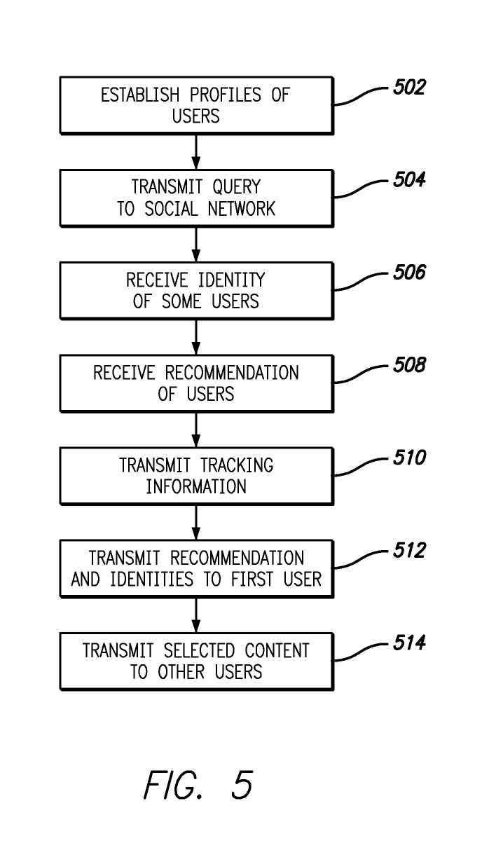

FIG. 5 is a simplified process flow of another machine-implemented method for a targeted delivery of content or metadata using a social network service according to yet another embodiment of the invention. The method is automatic and requires generally no human actions. First, a plurality of profiles of a plurality of users is automatically established in a database of a computer environment. (Step 502) The profiles are comprised of tracking information of content played by each of the users on a per-content basis on a plurality of devices. The tracking information is automatically generated by processing a plurality of images of each of the users to determine the identity of each of them, including in some embodiments the name of each. This processing is accomplished by one or more processors performing one or more facial recognition algorithms. The images are automatically generated by cameras in communication with the devices while the users were playing the content.

Next, a query comprised of the identity of one of the users is automatically transmitted to a social network server that is associated with a social network service. (Step 504) In response to the query an identity of a portion of the users is automatically received from the social network server. (Step 506) Each of these users is a member of the social network service and is associated with the first user. Also received from the social network server in response to the query is a plurality of content recommendations or preferences of these users. (Step 508) Next the tracking information indexed to the identity of the users and their content recommendations/preferences are transmitted to a content provider server associated with a content provider. (Step 510) The content provider server automatically transmits these content recommendations/preferences to the first user along with the identities of the users who are the source of the content recommendations/preferences. (Step 512) Additionally the content provider server automatically transmits selected content to the users. (Step 514) This selected content is content determined by the content provider to be linked to the tracking information, and can be for example commercial advertising programs. This linked content, for example, can be content that is targeted to users having a common preference, characteristic or background, such as for example users of a certain age group, a certain gender, occupation, income level, users who attended a certain college, etc.

In view of the above, it will be appreciated that embodiments of the invention overcome many of the long-standing problems in the art by providing for a targeted delivery of content and related metadata to one or more users of various types of electronic devices that are adapted to render or play the content. Images of each user are captured at various times while various different items of content are being played. According to one embodiment the images are processed via one or more facial recognition algorithms so that the identity of each of the users, including their names, is determined. This data is stored in a central server thereby establishing a database of profiles of these users. The profiles are comprised of tracking information of content played by each of the users on a per-content basis. The central server either can use this tracking information directly for the targeted delivery of the content, or it can transmit it to another server or another business entity, such as for example another content provider, for use by the other business entity.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A machine-implemented method for targeted delivery over a network comprising a plurality of devices, the method comprising:
receiving from a first device tracking information of content played by a first user on a per-content basis on the first device,
wherein at least a portion of the tracking information is generated by processing a plurality of images of the first user to determine an identity of the first user by performing facial recognition using at least one facial recognition algorithm by at least one processor, and
wherein the plurality of images is generated by a camera in communication with the first device while the first user was playing the content on the first device;
storing the tracking information indexed to the identity of the first user;
transmitting to a social network server a first query comprised of the identity of the first user, wherein the social network server is associated with a social network service;
receiving from the social network server in response to the first query an identity of a plurality of other users who are members of the social network service and who are associated with the first user;
transmitting to a content provider server associated with a content provider the tracking information indexed to the identity of the first user; and
transmitting to the plurality of other users an identity of at least a portion of the content that was played by the first user on the first device, wherein the transmitting of the identity of the at least the portion of the content occurs automatically and in response to the receiving of the identity of the plurality of other users.

2. The method of claim 1 further comprising transmitting selected content from the content provider server to the plurality of other users, wherein the selected content is content determined by the content provider server to be linked to the plurality of other users.

3. The method of claim 1 further comprising transmitting to the content provider server the identity of the plurality of other users.

4. The method of claim 1 wherein the identity of the at least the portion of the content comprises titles of the at least the portion of the content.

5. The method of claim 4 further comprising transmitting to the plurality of the other users designations by the first user of the titles which correspond to content that is preferred by the first user.

6. The method of claim 1 wherein the tracking information further comprises a number of times the content was played by the first user on the per-content basis, and wherein the at least the portion of the content comprises the content that was played a predetermined number of times by the first user.

7. The method of claim 1 wherein the content comprises a plurality of commercial advertising programs.

8. The method of claim 1 wherein the plurality of other users are associated with the first user by being within three degrees of separation from the first user.

9. The method of claim 1 wherein the plurality of other users are associated with the first user by being within one degree of separation from the first user.

10. The method of claim 1 wherein the plurality of other users are associated with the first user by a designation on the social network service as a friend of the first user.

11. The method of claim 1 wherein the transmitting to the plurality of other users further comprises transmitting social network information to the social network server for posting on a plurality of web pages of the social network service that are associated with the plurality of other users, wherein the social network information includes the identity of the at least the portion of the content that was played by the first user on the first device.

12. A machine-implemented method for targeted delivery over a network comprising a plurality of devices, the method comprising:
establishing in a computer environment a database of a plurality of profiles of a plurality of users,
wherein the plurality of profiles is comprised of tracking information of content played by each of the plurality of users on a per-content basis on a plurality of devices,
wherein the tracking information is automatically generated by processing a plurality of images of each of the plurality of users to determine an identity of each of the plurality of users by performing facial recognition using at least one facial recognition algorithm by at least one processor, and
wherein the plurality of images is generated by a plurality of cameras in communication with the plurality of devices while the plurality of users were playing the content on the plurality of devices;
transmitting to a social network server a first query comprised of the identity of a first user, wherein the first user is one of the plurality of users and wherein the social network server is associated with a social network service;
receiving from the social network server in response to the first query a plurality of content recommendations of a portion of the plurality of users who are members of the social network service and are associated with the first user;
automatically transmitting to a content provider server associated with a content provider the tracking information indexed to the identity of the portion of the plurality of users; and
transmitting to the first user the plurality of content recommendations of the portion of the plurality of users.

13. The method of claim 12 further comprising receiving from the social network server in response to the first query an identity of each of the portion of the plurality of users.

14. The method of claim 13 wherein the transmitting to the first user of the plurality of content recommendations further includes transmitting to the first user the identity of each of the portion of the plurality of users.

15. The method of claim 12 further comprising transmitting to the content provider server the plurality of content recommendations of the portion of the plurality of users.

16. The method of claim 12 further comprising transmitting selected content by the content provider server to the portion of the plurality of users, wherein the selected content is content determined by the content provider server to be linked to the tracking information.

17. A server for communicating with a first device of a first user, wherein the first device has a camera in communication with the first device, and wherein the server is further for communicating with a social network server associated with a social network service, the server comprising:
a memory; and
a processor coupled to the memory and operable to perform steps comprising:
receiving from the first device tracking information of content played by the first user on a per-content basis on the first device,
wherein at least a portion of the tracking information is generated by processing a plurality of images of the first user to determine an identity of the first user, and
wherein the plurality of images is generated by the camera while the first user was playing the content on the first device;
storing the tracking information indexed to the identity of the first user;
transmitting to the social network server a first query comprised of the identity of the first user;
receiving from the social network server in response to the first query an identity of a plurality of other users who are members of the social network service and who are associated with the first user;
transmitting to a content provider server associated with a content provider the tracking information indexed to the identity of the first user; and
transmitting to the plurality of other users an identity of at least a portion of the content that was played by the first user on the first device, wherein the transmitting of the identity of the at least the portion of the content is in response to the receiving of the identity of the plurality of other users.

18. The server of claim 17 wherein the steps further comprise transmitting to the content provider server the identity of the plurality of other users who are members of the social network service and who are associated with the first user.
